(19) United States
(12) Patent Application Publication
(10) Pub. No.: US 2006/0042076 A1
(43) Pub. Date: Mar. 2, 2006

(54) Bus bar system for heatable glass

(75) Inventor: Michael A. Previti, Alpharetta, GA (US)

Correspondence Address: SENNIGER POWERS, ONE METROPOLITAN SQUARE, 16TH FLOOR, ST LOUIS, MO, 63102, US

(73) Assignee: Fry's Metals, Inc.

(21) Appl. No.: 10/925,306

(22) Filed: Aug. 24, 2004

(51) Int. Cl. H01P 11/00

(52) U.S. Cl. 29/825; 29/600; 343/713; 343/704

(57) ABSTRACT

A composition for forming an electrically conductive bus, which comprises a polymer and conductive filler particles. A composition for forming an electrically conductive bus, comprising silver-based flakes within a polymer adhesive carrier such as polyurethane for forming a conductive bus for vehicle glass. A method for forming a glass laminate structure such as a windshield, with an electrically conductive bus for delivering current to a conductor for resistive heating of the structure.

### FIELD OF THE INVENTION

The invention relates generally to a composition and method for forming an electrically conductive bus for delivering electrical current to glass, and to a composition and method for forming vehicle glass, such as windshields, which incorporates a bus bar to distribute current to a conductor of the vehicle glass for resistive heating for defogging and deicing.

### BACKGROUND OF THE INVENTION

Glass laminate structures, such as windows and windshields for vehicles or windows, are typically equipped with systems for heating for defogging and deicing. Typically, hot air is forced through vents across the interior of the glass to heat the glass by convection. Heaters and blowers for deicing and defogging add vehicle weight, thereby reducing fuel economy. In winter an engine may take several minutes to warm up sufficiently to generate hot air for defogging and deicing.

Rather than relying on hot air, it is known to heat vehicle glass by employing resistive heat generated from conducting current through electrically conductive features, such as conductive films or fine wires within or otherwise associated with the glass. Bus bars for delivering current to the conductive films or fine wires are prone to develop hot spots or breaks. Hot spots develop as the result of inconsistent electrical conductivity throughout the bus bar structure.

One prior art method for applying a bus bar to a windshield has been to deposit a solvent-based silver or silver alloy composition onto flat glass. The composition on the glass is then heated to a temperature, such as above about 400° C. as disclosed in U.S. Pat. No. 6,625,875, at which the silver-based material melts together to form a continuous conductor. This should be performed early in the manufacturing process, even before bending the glass to its shape of, for example, a curved windshield, because after the glass is shaped, one risks damage if one heats the glass up to temperatures required for coalescing the silver. A disadvantage of applying the silver-based material prior to bending the windshield to its final shape, however, is that each windshield that must be scrapped due to mistakes in the bending process comprises at least one scrapped silver bus bar. Scrap silver must be recovered and reworked for both economic and environmental reasons. This is substantial because, by some estimates, between about 20% and 30% of the windshields are scrapped during processing.

Another approach for applying a bus bar has been to use pre-forms as in U.S. Pat. No. 5,861,606, such as Cu foil preforms. Copper is subject to oxidation, and the pre-forms must be kept in inventory in a variety of forms to supply manufacture of a variety of windshield shapes.

### SUMMARY OF THE INVENTION

Among the objects of the invention, therefore, is the provision of a conductive composite material that can be in paste or film form that will provide superior conductivity and reliability in distributing current to glass such as a windshield. It is a further object of the invention to provide a windshield such that, when current flows through the electrical feature(s) located therein, heat is generated to quickly defog or deice the windshield.

Briefly, therefore, the invention is directed to a composition for forming an electrically conductive bus for delivering electrical current to a conductor for resistive heating of a glass surface. The composition comprises a mixture which is flowable and solidifiable for formation of the conductive bus, the mixture comprising a polymer and conductive filler particles, which impart a resistivity below about 9.0×10⁻⁵ Ω·cm to the conductive bus.

The invention is also directed to a bus bar composition comprising a mixture which is flowable and solidifiable for formation of the conductive bus, the mixture comprising polyurethane and conductive silver-based filler particles.

The invention is also directed to a bus bar composition comprising a polymer and silver-based flakes as conductive filler particles wherein at least about 30% by weight of the silver-based flakes have a particle size greater than about 6.0 μm, and at least about 30% by weight of the silver-based flakes have a particle size less about 6.0 μm.

The invention is further directed to a bus bar composition comprising a polymer and silver-based flakes as conductive filler particles wherein at least about 30% by weight of the silver-based flakes were manufactured under a first set of parameters and at least about 30% by weight of the silver-based flakes were manufactured under a second set of parameters distinct from the first set of parameters.

In another aspect, the invention is a glass laminate structure for a vehicle comprising an electrically conductive bus comprising electrically conductive filler particles in a polymer and having a resistivity of less than about 9.0×10⁻⁵ Ω·cm within the glass laminate structure.

In a further aspect the invention is a glass laminate structure for a vehicle comprising an electrically conductive bus within the glass laminate structure, the electrically conductive bus comprising silver-based flakes distributed in a polymer, wherein at least about 30% by weight of the silver-based flakes have a particle size greater than about 6.0 μm, and at least about 30% by weight of the silver-based flakes have a particle size less about 6.0 μm.

In a further aspect the invention is an electrically conductive bus for delivering heat to a glass surface, comprising a solidified polymer and conductive filler particles distributed within the solidified polymer, wherein the conductive bus has a resistivity below about 9.0×10⁻⁵ Ω·cm.

The invention is also directed to a method of manufacturing a glass laminate structure for a vehicle, comprising depositing a bus bar composition comprising a polymer and conductive filler particles onto a surface of a first glass component, superposing a second glass component over said surface of the first component on which the bus bar composition is deposited, and compressing the first and second glass components together with the bus bar composition therebetween.

The invention is further directed to a method comprising depositing a bus bar composition comprising a polymer and conductive filler particles onto a surface of a first glass component, wherein the conductive filler particles comprise silver-based flakes and wherein at least about 30% by weight of the silver-based flakes have a particle size greater than about 6.0 μm, and at least about 30% by weight of the silver-based particles have a particle size less about 6.0 μm; superposing a second glass component over said surface of the first component on which the bus bar composition is deposited; and compressing the first and second glass components together with the bus bar composition therebetween.

Another aspect of the invention is a method comprising depositing a bus bar composition comprising a polymer and conductive filler particles onto a surface of a first glass component which has been pre-shaped into a curved vehicle window configuration to form a bus bar structure on said surface; superposing a second glass component pre-shaped into the curved vehicle window configuration over the surface of the first glass component with the bus bar structure thereon; and compressing the first and second glass components together with the bus bar structure therebetween to form the glass laminate structure.

Other objects and features of this invention will be in part apparent and in part pointed out hereinafter.

### BRIEF DESCRIPTION OF THE DRAWINGS

FIG. 1 is a front view of a windshield with the conductive composite material deposited thereon as a bus bar.

FIG. 2 is an edge-on view of the glass laminate structure.

### DETAILED DESCRIPTION OF THE PREFERRED EMBODIMENTS

In accordance with this invention, a composition has been developed for forming a conductive composite material. The composition comprises a polymer and a conductive filler material, and is useful in forming a bus bar of various sizes and shapes to carry current to a glass substrate. More specifically, it carries current that is dispersed across a glass substrate for resistive heating. The dispersion across the glass substrate is accomplished by a conductive coating or other current distributor with which the bus bar electrically communicates. The composition is typically compacted such as between two pieces of glass in a glass laminate structure. Upon compaction the conductive filler particles are forced into close physical and electrical communication with each other so they can function to carry electrical current. The overall composition is prepared so that it is moderately flowable for application to a glass surface and then cured, such as by heating, into a final solid form.

The invention is applicable to bus bars and bus bar compositions for delivering electrical current to any glass structure, and for illustration purposes only, is described in the following preferred embodiments in the context of a windshield. But the invention encompasses vehicle glass other than strictly windshields, such as rear windows; vehicle glass for any land, marine, air, or space vehicle; mirror glass; and glass for permanent structures such as buildings.

The polymeric material incorporated into the composition of the invention is a durable, low modulus polymer. Generally, the polymer can be a mixture or adhesive of an organic polymer containing the elements carbon and hydrogen, along with one or more of the elements oxygen, nitrogen, sulfur, silicon, or a halogen in its repeating unit. The polymer may be thermoplastic or thermosetting, and in either elastomer or gel form. For certain applications, a thermoplastic polymer is preferred because a thermoplastic polymer softens slightly upon heating a windshield during lamination, and with such softening coupled with lamination pressure, the thermoplastic polymer flows to provide more integral adhesion to the glass and to fill irregularities in the micro-scale topography of the glass surface. This polymer functions as an adhesive carrier for the bus bar composition, and in this aspect distinguishes the composition from silver bus bar compositions which are solvent-based and contain little or no polymer.

Exemplary polymers include polysulfones, polyaryl sulfones, polyether sulphones, polyether imides, polyacrylates, urethane acrylates, linear polyesters, linear polyurethanes, epoxides, polyimides, thermosetting polyurethanes, polysiloxanes, polychloroprene, polyamides, polyarylates, polyvinyl alcohol, polyalkylether, polyalkylester, phenoxies, polybenzimidazole, polyvinyl chloride, polyvinylidene chloride, polychlorotrifluoroethylene, polyphenylene oxide, cellulose acetatebutyrate, nylons, and metal chelate polymers. In a preferred embodiment, the polymer is a thermoplastic, most preferably a thermoplastic polyurethane.

Typically, between about 10 wt % and about 40 wt % of polymer is present in the composition of polymer plus conductive filler particles. Preferably, between about 10 wt % and about 20 wt % of polymer is initially present. More preferably, between about about 10 wt % and about 15 wt % of polymer is initially present.

The composition of the invention further comprises conductive filler material particles. Generally, the filler material is a conductive material that can be mixed with the polymer such that, in the final product, the conductive material will be able to conduct electrical current through the composite material. In a preferred embodiment, the conductive filler material is a metal. More preferably, the conductive filler material is silver-based, such as silver or silver alloy. Silver is preferred in one embodiment because it does not oxidize as quickly as other metals and is a reliable electrical conductor. Adequate silver particles such as flakes are readily available in various shapes and sizes from commercial suppliers. While other conductive materials can be used, the invention is described hereinafter in terms of silver as the conductive material for illustration purposes only.

In order to be readily mixed with the polymer and other materials when preparing the composite conductive material, the conductive filler material particles must be in a morphology that is readily dispersed throughout the mixture. To this end, silver in flake and/or powder form are preferred embodiments of the conductive filler material. A flake is defined as a generally thin, flat piece of material. As contemplated here, a flake is a particle that has a length and a width at its longest and widest points that is at least about five times the average particle thickness. Silver flakes and powder particles often have a proprietary coating applied by the flake/powder manufacturer to faciliate mixing, to improve dispersion, and to reduce oxidation.

The silver flakes or powder particles generally range in size from about 0.1 to about 25 μm at their maximum dimension. Preferably, the size of the silver particles will range from about 0.5 to about 20 μm, and more preferably from about 1 to about 18 μm. In a preferred embodiment, the particles have a size distribution that is not strictly centered around a particular size. Rather, there is a substantial portion of relatively smaller particles and a substantial portion of relatively larger particles. This size distribution facilitates close packing in the ultimate compressed composition, and therefore electrical communication of high integrity throughout the composition. For example, at least about 30% by weight of the silver particles are greater than about 6.0 μm and at least about 30% by weight of the silver particles are less than about 6.0 μm in size. In another preferred embodiment, at least about 30% by weight of the silver particles have a size between about 6.0 μm and about 14 μm, and at least about 30% by weight have a size between about 2.0 μm and about 6.0 μm.

In one preferred embodiment of the invention, at least two different sources of silver are used, with each source of silver being manufactured by distinct processing parameters. In one embodiment, at least about 30% by weight of the silver particles are manufactured under a first set of parameters and at least about 30% by weight of the silver particles are manufactured under a second distinct set of parameters. Surprisingly, and without being bound to a particular theory, by using at least two different sources of silver manufactured by distinct processing parameters, the combined filler material particles appear to have a heterogeneity in properties which, when packed, provides an electrical bus with higher integrity than systems where only one source of silver is employed. The actual preparation of silver flakes is well known in the industry, and is not an element of this invention. For example, U.S. Pat. No. 4,331,714 discloses that silver flakes are prepared by bead-milling of irregularly shaped precipitated silver powders. U.S. Pat. No. 4,859,241 also discloses milling preparation of silver flakes. By selecting at least two distinct sources of silver flakes in accordance with one embodiment of the invention, one is ensured of distinct process parameters such as milling media, milling time, milling solvent, coating, or the like. Among the many sources of silver flakes are Technic Inc. (Cranston, R.I.), Fukuda Metal Foil Powder Co. (Japan), Ferro Corp. (Cleveland, Ohio), and Metalor (Switzerland).

In an embodiment comprising at least two sources of silver manufactured by distinct process parameters, the concentration of each portion is controlled. Preferably, the first portion of silver makes up from about 40% to about 60% by weight of the total silver added to the conductive composite material. More preferably, the first portion of silver makes up from about 45% to about 55% by weight of the total silver. Most preferably, the first portion of silver makes up from about 48% to about 52% by weight of the total silver.

In one preferred embodiment, a first portion of silver prepared under a first set of parameters, ranging from about 0.1 to about 15 μm and making up from about 40% to about 60% of the total silver, is combined with a second portion of silver prepared under a second set of parameters, ranging from about 0.5 to about 20 μm and making up from about 40% to about 60% of the total silver. In one such embodiment, a first portion of silver, ranging from about 2 to about 14 μm and making up from about 48% to about 52% of the total silver, is combined with a second portion of silver, ranging from about 2 to about 13 μm and making up from about 48% to about 52% of the total silver. In this preferred embodiment, it is also preferred that, of all the silver particles from both sources at least about 30% by weight be less than 6.0 μm and at least about 30% by weight be greater than 6.0 μm, such that the size distribution discussed above is achieved.

The conductive filler material is present in the composition between about 20 wt % and about 65 wt %. In one such embodiment, the conductive filler material composition constitutes between about 40 wt % and about 55 wt %.

In addition to the polymer and the conductive filler material, the bus bar composition optionally comprises an inorganic SiO₂ or fumed silica to help keep the conductive filler material suspended. Also, this additive increases the conductive composite mixture's thixotropy, allowing accurate placement of material during dispensing operations. The inorganic SiO₂ or fumed silica can be uncoated or silane coated. Cabosil M5, available from Cabot Corp. (Tuscola, Ill.), and R202, available from Degussa Corp. (Germany), are exemplary fumed silicas. In one embodiment, the relative weight percent of the SiO₂ or fumed silica in a the conductive composite mixture formula is from about 0.1 wt % to about 10 wt %. For example, the SiO₂ or fumed silica is present from about about 0.5 wt % to about 5 wt %. In one such embodiment, the SiO₂ or fumed silica is present from about about 0.5 wt % to about 2.5 wt %. These materials are readily available in the industry, as they are commonly used in food products, packaging, and multiple types of adhesives.

The composition comprises at least one solvent as a viscosity altering additive. The solvent is able to dissolve the polymer in the mixture and evaporate on exposure to heat during windshield bonding processing steps. Low boiling point solvents are typically used. Further, mixed solvent systems with different boiling points are also used to avoid volcanoeing, pop corning, and other surface defects on the final surface of the conductive composite material. The total solvent concentration is typically between about 1 wt % and about 60 wt %. For example, the total solvent concentration is between about 10 wt % to about 50 wt %. In one preferred embodiment, the total solvent concentration is between about 25 wt % to about 35 wt %.

Exemplary solvents used in the current invention include NMP (n-Methyl Pyrolidone); DBE-2, DBE-3, and DBE-6 (Dibasic Esters); DPMA (Dipropylene glycol methylether acetate); BLO (Gamma-HydroxyButyric Acid Lactone); EEP (Ethyl-3-ethoxypropionate); DMF (N,N-Dimethyl Formamide); Cyclohexanone; Cyclohexane; Cyclopentane; PMA (PM Acetate); Xylene; NNP (N-Nitropropane); NBA (N-Butyl Acetate); 2-Methoxyethanol; 2-Pentanone; Toluene; IPA (Isopropyl Alcohol); MEK (Methyl Ethyl Ketone); Acetone; Ethanol; and mineral spirits.

Additionally, several other components may be present in the composition. These may include wetting agents, coupling agents, dispersing agents, air release agents, pigments, dyes, UV tracer dyes, and UV stabilizers. Further, the composition is preferably free of glass frit. One exemplary wetting agent is ARA dehydran, available from Fitz Chem Corp. (Itasca, Ill.). One exemplary stabilizer, useful for its anti-yellowing function, is Tinuvin 5050, available from Ciba-Geigy Corp. (Ardsley, N.Y.). The total concentration of these additives is between about 0.01 wt % to about 6.0 wt % of the mixture. For example, the concentration of these additives is between about 0.04 wt % and about 3.0 wt % of the mixture. In one preferred embodiment, the concentration of these additives is between about 0.05 wt % and about 1.0 wt % of the mixture.

Forming the composition according to the invention begins with washing the polymer material with deionized water to remove impurities and drying the polymer to remove moisture. Next, the prepared polymer is mixed with an amount of solvent to dissolve and disperse the polymer in a stainless steel mixing apparatus. This is performed at a temperature between about 50° C. to about 100° C. and with high shear mechanical mixing.

Next, the other various non-silver additives are added to the mixture. The viscosity of the mixture can be reduced by increasing the temperature of during the mixing stage. In any event, the temperature of the mixture should not exceed 90° C. The viscosity of the composition is such that it can be applied to glass by syringe extrusion or one of the other various application methods described below. For example, in one embodiment, the viscosity is at least about 15,000 poise and less than about 150,000 poise.

After these components of the mixture have been well dispersed, the silver is slowly added to the mixture. When the silver is first added, the mechanical mixing is at low shear and quite slow to gently introduce the silver to the mixture and reduce the potential for dangerous silver dust formation. After the total amount of silver is added to the mixture, the mixing is conducted at much higher shear. To promote proper and consistent dispersion, the mixing operation may be stopped at fixed intervals to remove unmixed material from the interior walls and blades of the mixing apparatus. Mixing is also performed under vacuum to remove air from the mixture. Typically, the mixture is mechanically mixed from about 20 to about 180 minutes. More typically, the mixture is mechanically mixed from about 60 to about 120 minutes. In alternative embodiments, the mixture process may employ ball milling or roll milling as opposed to the mechanical mixing operation described above.

Once the composition is prepared, it is used to form a conductive composite structure which, upon final processing, serves as a bus for the windshield. This bus delivers current to a conductor on or otherwise associated with the glass for distribution of current across the glass for resistive heating, thereby generating heat to defog or deice the windshield. The conductor on the glass is typically a transparent electroconductive coating as is known in the art (see, e.g., U.S. Pat. Nos. 4,655,811; 4,994,650; 5,165,972; 5,324,374; 5,700,305). Such a coating is applied by sputter coating or the like.

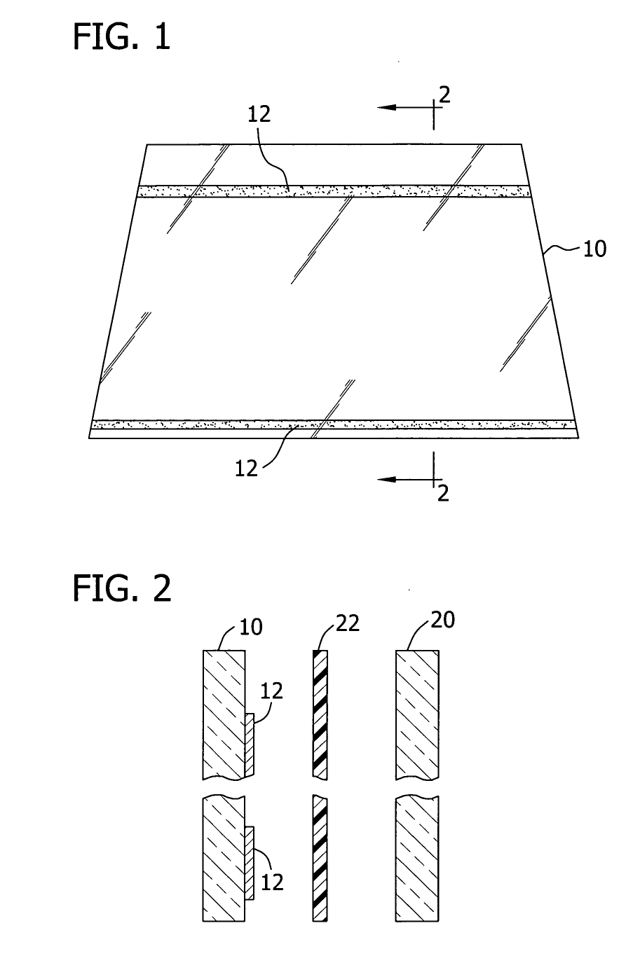

FIG. 1 illustrates one possible bus configuration on a glass substrate 10, where two bus bars 12 are applied horizontally across the top and bottom of the glass substrate 10. A cross section of the final laminated structure in FIG. 2 shows the two glass substrates, 10 and 20, with the bus bars 12 applied to the interior surface of one of the glass substrates 10. Standard construction of a glass laminate structure also typically comprises a polymer reinforcement layer 22 between the glass substrates, as further detailed below.

The current invention does not substantially interfere with the standard windshield lamination process. Only one step, in which the composition is applied to the laminate, is added to the standard industry practice. Specifically, the glass laminate structure begins with two substantially similar pieces of flat glass. These two glass substrates are typically formed from a larger piece of glass stock and may be between about 1 mm to about 3 mm thick. The length and width of the glass substrates will vary depending on the particular application. The glass substrates are then formed into the desired shape by deformation at a temperature of at least about 650° C.

After bending to the desired windshield shape and other operations, the composition of the invention is then applied to the interior surface of at least one of the glass substrates. By applying the composition to the curved glass substrate such as a windshield after bending, the incidence of silver bus bar scrap is greatly reduced. In particular, glass substrates in a glass bending operation can be broken or develop flaws during bending or related operations, which can be detected by industry standard inspection techniques. These broken or flawed pieces are scrapped or reworked. By applying the bus bar composition only after bending, sputtering, and inspection, the composition is only applied to glass much more likely to survive the entire manufacturing process, and much less likely to be scrapped. In other words, with this invention most of the relatively high proportion of windshields that are scrapped do not carry expensive silver bus bars with them, because they are determined to be scrap prior to applying the composition of the invention. This greatly reduces the incidence of bus bar scrap.

This scrap-reduction aspect of the invention is facilitated by the fact that the silver is within a polymer that functions as an adhesive carrier. Because of this, it is not necessary to heat the silver bus bar composition of the invention up to a high temperature to get it to flow together and adhere to the glass as it is with other systems, such as in U.S. Pat. No. 6,625,875. The composition of the invention only must be heated to a modest temperature, such as up to about 150° C., to drive off the solvent. Because it is not necessary to heat the present invention to temperatures substantially above about 150° C., the bus bar composition can be applied late in the windshield manufacturing process where, for each windshield, the risk of damage or becoming scrap is greatly diminished. Loss of silver to scrap is therefore greatly reduced. If it were necessary to heat the composition to substantially above about 150° C., then the composition would have to be applied prior to bending of the windshield because a) it is either generally unacceptable to heat the windshield to high temperatures after bending, or b) special handling equipment is required to heat the windshield to high temperatures after bending.

One aspect of the invention, therefore, is that the bus bar composition is applied after all windshield forming operations performed at a temperature above about 175° C., preferably about 150° C., are completed. Stated another way, after application of the bus bar composition, no operations involving a temperature above about 175° C., and preferably no operations involving a temperature above about 150° C., are performed during the entire remaining manufacturing process. The bus bar composition is therefore applied after elevated temperature deformation to impart the curved windshield shape, and no elevated temperature deformation processes are performed on the glass after application of the bus bar composition. The bus bar composition is therefore deposited onto a glass component which has been pre-shaped into a curved vehicle window configuration, because to shape the window by curving requires higher temperatures.

The composition can be applied in any desired configuration, such as the one shown in FIG. 1, and can be in either paste or thin film form. In film form, the mixture can be applied by film taping. If the mixture is in paste form, possible methods of application include syringe extrusion, stencil printing with a flexible stencil, spraying, jetting, with a hand probe, or doctor blading. In production, these methods are typically automated by using robotic application techniques, which also improve the reliability and consistency of the paste or film deposit. The temperature during the application stage is maintained below about 150° C. The thickness of the paste or film deposit should be less than about 600 μm for best results. Preferably, the thickness of the deposit is between about 50 and about 600 μm. More preferably, the thickness of the deposit is between about 250 μm and about 525 μm. Even more preferably, the thickness of the deposit is between about 250 μm and about 350 μm.

After the deposit has been applied, the laminate structure is brought together and exposed to a low temperature heating or cure to remove the solvents from the composition. If permitted to remain in the laminate structure, the solvent would result in a visual failure in the final glass laminate structure. This heating should be between about 85° C. and about 175° C., preferably between about 105° C. and about 175° C., and more preferably between about 125° C. and 165° C. The maximum temperature of this heating and any subsequent operations is kept low because the glass substrate is relatively delicate, and the risk of cracking, loss of integrity, or oxidation of any sputter coating is kept low by avoiding any temperature above about 175° C., and preferably by avoiding any temperature above about 150° C. This heating has a duration from about 30 to about 180 minutes. Heating can take place in any conventional means for heating a workpiece, such as a furnace, box oven, forced convection oven, or reflow oven, and can be performed under vacuum, in an inert atmosphere (e.g., nitrogen or argon), or in air. The exact time and temperature will depend upon customer application, the complexity of the glass contour, and the amount of material originally deposited on windshield. In addition to removing the solvent, this heat treatment also softens the thermoplastic polymer of the mixture, promoting flow into the glass surface irregularities and facilitating good adhesion to the glass surfaces.

After heating, the deposit thickness is typically between about 5 μm to about 350 μm. Further, the post-heating composite material is made up of between about 70 wt % and about 85 wt % silver. Preferably, the post-heating composite material has a silver concentration between about 75 wt % and about 80 wt %. In one preferred embodiment, silver is present in the post-heating composite material in a concentration of about 79 wt %.

After the composite material is cured, the resistivity of the conductive structure is below about 9.0×10⁻⁵ Ω·cm. More preferably, the resistivity of the cured conductive structure is below about 5.0×10⁻⁵ Ω·cm. Even more preferably, the resistivity of the cured conductive structure is below about 1.0×10⁻⁶ Ω·cm. The lower resistivity values achieved by the present invention indicate greater conductivity, and therefore greater efficiency and reliability in the final conductive structure. The increase in efficiency and reliability is in accordance with one of the stated objectives of the invention: to minimize the presence of hot spots in the final conductive structure.

With the cured conductive structure in place, the laminate structure is formed by applying a reinforcement polymer layer 22 to the interior surface of one of the glass substrates 10, referring to FIG. 2. This reinforcement layer 22 is added to help prevent shattering of the windshield. Polyvinyl butyral is commonly used in this regard throughout the industry, and the manner of application is well known to those skilled in the art.

This glass laminate structure is then reheated under pressure to allow the layers to form an excellent bond, which results in superior conductivity and performance of the bus bar in the final assembly. The specific parameters of the final forming operation, including the amount of pressure, the temperature, and the duration, are all in accordance to standard industry practice. Standard glass laminating processes can be found in, e.g., U.S. Pat. Nos. 6,737,151 ('151); 5,960,606; and 5,324,374, the full disclosures of which are incorporated herein by reference. For example, the '151 patent discloses applying about 200 psig at about 135° C. for about 20 minutes. For the immediate invention, the temperature should not exceed about 150° C. in order to maintain the integrity of the conductive structure.

The final glass laminate structure, useful as a windshield, conducts current through the bus bars formed by the conductive composite material structure. The bus bars deliver the current to the conductor of the glass, such as to a conductive coating which has been sputter coated or otherwise applied to a major surface of the glass according to standard industry practice. As electrical current is then distributed across the glass surface, heat is generated via resistance, which is then transferred to the glass and its surfaces by conduction principles. The invention can effectively defog and deice a windshield in as little as approximately three minutes.

The present invention is illustrated by the following examples, which are merely for the purpose of illustration and not to be regarded as limiting the scope of the invention or manner in which it may be practiced.

### EXAMPLE 1

A composition was prepared according to the following:

| Component | Weight (%) |
|---|---|
| Polyurethane | 10-40 |
| Total solvents | 10-50 |
| Wetting agent | 0.01-0.5 |
| Coupling agent | 0.01-5 |
| Fumed silica | 0.5-5 |
| UV absorber/Anti-yellowing | 0.01-0.5 |
| stabilizer | |
| Silver flake #1 | 20-40 |
| Silver flake #2 | 20-40 |

First, the thermoplastic polymer was rinsed with deionized water and dried to remove excess debris and moisture. The mixture was formed by adding the solvents to the thermoplastic polymer at 25-100° C. over 60 minutes in a mixing apparatus. The other non-silver components were then added to the mixture. Finally, the silver flakes were added to the mixture at low shear. The complete mixture was further mixed for 30-60 minutes to ensure proper distribution of all the components. The mixing apparatus was stopped every 10 minutes to remove any part of the mixture that was adhering to the side of the mixing tank or the mixing blades.

### EXAMPLE 2

The following composition was prepared according to the procedure of Example 1:

| Component | Weight (%) |
|---|---|
| Polyurethane | 13.28 |
| Total solvents | 31.58 |
| Wetting Agent | 0.04 |
| Fumed silica | 2.00 |
| UV absorber/Anti-yellowing | 0.05 |
| stabilizer | |
| Silver flake #1 | 26.50 |
| Silver flake #2 | 26.50 |

Silver Flakes 1 and 2 were procured from two distinct sources and were therefore prepared under respectively distinct parameters. The Flake 1 and Flake 2 proportions were equivalent to each other in weight, and cumulatively they satisfied the parameter of the invention of at least 30 wt % being greater than about 6 μm in size and at least 30 wt % being less than about 6 μm in size. The particular size distribution within the Flake 1 proportion was 90 wt %<14.5 μm, 50 wt %<6.4 μm (therefore 50 wt %>6.4 μm), and 10%<2.1 μm. The particular size distribution within the Flake 2 proportion was 95 wt %<18.35 μm, 90 wt %<13 μm, 50 wt %<5.6 μm (therefore 50 wt %>5.6 μm), and 10 wt %<2.0 μm.

### EXAMPLE 3

Two pieces of glass with dimensions of about 114 cm by about 91 cm were cut from glass stock about 2 mm thick. The two pieces of glass were then heated to 650° C. and bent into the desired shape of a standard automotive windshield. The windshield then underwent multiple polishing and washing stages per typical industry practice. After confirming that the windshield passed all test and quality criteria, it was then moved to further manufacturing operations. The inner layer of the top glass piece was sputter coated with a conductive layer. The composition of Example 2 was then applied in paste form using a robotic dispenser in a bus bar configuration to the interior surface of one of the sputtered glass substrate. This substrate was then cured by heating it between 125° C. and 150° C. for 60 minutes to remove the solvent and soften the polymer.

### EXAMPLE 4

After the composition of Example 2 was applied and cured according to Example 3, the resistivity of the conductive composite structure was measured. A standard multimeter and four wire Kelvin probe set was used to measure the overall resistance of the structure to be 0.0143 Ω. After the length, width, and thickness of the structure were also measured, the resistivity (ρ) was calculated according to the following formula:
ρ=(R*A)/l
where R is the measured resistance, A is the cross sectional area of the structure, and l is the length of the structure. Therefore, the resistivity for the structure having length, width, and thickness dimensions of 7.62 cm, 1.00 cm, and 0.025 cm, respectively, was calculated to be 4.69×10⁻⁵ Ω·cm.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

The foregoing relates to a limited number of embodiments that have been provided for illustration purposes only. It is intended that the scope of invention is defined by the appended claims and there are modifications of the above embodiments that do not depart from the scope of the invention.

What is claimed is:

1. A composition for forming an electrically conductive bus for delivering electrical current to a conductor for resistive heating of a glass surface, the composition comprising:
a mixture which is flowable and solidifiable for formation of the conductive bus, the mixture comprising:
a polymer; and
conductive filler particles which impart a resistivity below about 9.0×10⁻⁵ Ω·cm to the conductive bus.

2. The composition of claim 1 wherein the conductive filler particles impart a resistivity below about 5.0×10⁻⁵ Ω·cm to the conductive bus.

3. The composition of claim 1 wherein the conductive filler particles impart a resistivity below about 1.0×10⁻⁶ Ω·cm to the conductive bus.

4. The composition of claim 1 wherein the polymer is a low modulus polymer.

5. The composition of claim 1 wherein the polymer comprises a thermoplastic polymer.

6. The composition of claim 1 wherein the polymer is selected from the group consisting of polysulfones, polyaryl sulfones, polyether sulphones, polyether imides, polyacrylates, urethane acrylates, linear polyesters, linear polyurethanes, epoxides, polyimides, thermosetting polyurethanes, polysiloxanes, polychloroprene, polyamides, polyarylates, polyvinyl alcohol, polyalkylether, polyalkylester, phenoxies, polybenzimidazole, polyvinyl chloride, polyvinylidene chloride, polychlorotrifluoroethylene, polyphenylene oxide, cellulose acetatebutyrate, nylons, and metal chelate polymers.

7. The composition of claim 1 wherein the polymer comprises polyurethane.

8. The composition of claim 1 wherein the polymer is present in a concentration of between about 10 wt % and about 40 wt %.

9. The composition of claim 1 wherein the polymer is present in a concentration of between about 10 wt % and about 40 wt % and the conductive filler particles comprise silver flakes.

10. The composition of claim 1 wherein the conductive filler particles are present in a concentration between about 20 wt % and about 65 wt %.

11. The composition of claim 1 wherein the conductive filler particles are present in a concentration between about 40 wt % and about 55 wt %.

12. The composition of claim 1 wherein the conductive filler particles are silver-based.

13. The composition of claim 1 wherein the conductive filler particles are silver-based flakes.

14. The composition of claim 1 wherein the conductive filler particles comprise silver-based flakes and wherein at least about 30% by weight of the silver-based flakes have a particle size greater than about 6.0 μm, and at least about 30% by weight of the silver-based flakes have a particle size less about 6.0 μm.

15. The composition of claim 1 wherein the conductive filler particles comprise silver-based flakes and wherein at least about 30% by weight of the silver-based flakes have a particle size between about 6.0 μm and about 14 μm, and at least about 30% by weight of the silver-based flakes have a particle size between about 2.0 μm and about 6.0 μm.

16. The composition of claim 1 wherein the conductive filler particles comprise silver-based flakes and wherein at least about 30% by weight of the silver-based flakes were manufactured under a first set of parameters and at least about 30% by weight of the silver-based flakes were manufactured under a second set of parameters distinct from the first set of parameters.

17. The composition of claim 1 wherein the composition further comprises a thixotropic additive.

18. The composition of claim 17 wherein the thixotropic additive is silicon dioxide or an inorganic fumed silica.

19. The composition of claim 17 wherein the thixotropic additive is present in a concentration of between about 0.1 wt % and about 10 wt %.

20. The composition of claim 17 wherein the thixotropic additive is present in a concentration of between about 1.5 wt % and about 2.5 wt %.

21. The composition of claim 1 wherein the composition further comprises a viscosity-altering additive.

22. The composition of claim 21 wherein the viscosity-altering additive comprises at least one low boiling point solvent.

23. The composition of claim 21 wherein the viscosity altering additive is selected from the group consisting of N-methyl pyrolidone; DBE-2, DBE-3, and DBE-6; dipropylene glycol methylether acetate; gamma-hydroxybutyric acid lactone; ethyl-3-ethoxypropionate; N,N-dimethyl formamide; cyclohexanone; cyclohexane; cyclopentane; PM acetate; xylene; N-nitropropane; N-butyl acetate; 2-methoxyethanol; 2-pentanone; toluene; isopropyl alcohol; methyl ethyl ketone; acetone; ethanol; mineral spirits; and any combination thereof.

24. The composition of claim 1 wherein the composition further comprises at least one wetting agent and at least one UV stabilizer.

25. The composition of claim 24 wherein the wetting agent and UV stabilizer have a total concentration of between about 0.01 wt % and about 6.0 wt %.

26. A composition for forming an electrically conductive bus for delivering electrical current to a conductor for resistive heating of a glass surface, the composition comprising:
a mixture which is flowable and solidifiable for formation of the conductive bus, the mixture comprising:
a polymer; and
conductive silver-based filler particles.

27. The composition of claim 26 wherein the polymer comprises polyurethane.

28. The composition of claim 26 wherein the polymer constitutes between about 10 wt % and about 40 wt % of the mixture and the conductive silver-based filler particles comprise silver flakes.

29. A composition for forming an electrically conductive bus for delivering electrical current to a conductor for resistive heating of a glass surface, the composition comprising:
a polymer; and
silver-based flakes as conductive filler particles wherein at least about 30% by weight of the silver-based flakes have a particle size greater than about 6.0 μm, and at least about 30% by weight of the silver-based flakes have a particle size less about 6.0 μm.

30. The composition of claim 29 wherein the polymer comprises polyurethane.

31. The composition of claim 29 wherein the polymer is present in a concentration of between about 10 wt % and about 40 wt %.

32. A composition for forming an electrically conductive bus for delivering electrical current to a conductor for resistive heating of a glass surface, the composition comprising:
a polymer; and
silver-based flakes as conductive filler particles wherein at least about 30% by weight of the silver-based flakes were manufactured under a first set of parameters and at least about 30% by weight of the silver-based flakes were manufactured under a second set of parameters distinct from the first set of parameters.

33. The composition of claim 32 wherein the polymer comprises polyurethane.

34. The composition of claim 32 wherein the polymer constitutes between about 10 wt % and about 40 wt % of the composition and constitutes polyurethane.

35. A glass laminate structure for a vehicle comprising an electrically conductive bus comprising electrically conductive filler particles in a polymer and having a resistivity of less than about 9.0×10⁻⁵ Ω·cm within the glass laminate structure.

36. The glass laminate structure of claim 35 wherein the electrically conductive filler particles are silver-based flakes.

37. The glass laminate structure of claim 35 wherein the conductive filler particles comprise silver-based flakes and wherein at least about 30% by weight of the silver-based flakes have a particle size greater than about 6.0 μm, and at least about 30% by weight of the silver-based particles have a particle size less about 6.0 μm.

38. The glass laminate structure of claim 35 wherein the polymer comprises thermoplastic polyurethane.

39. The glass laminate structure of claim 37 wherein the polymer comprises thermoplastic polyurethane.

40. A glass laminate structure for a vehicle comprising:
an electrically conductive bus within the glass laminate structure, the electrically conductive bus comprising silver-based flakes distributed in a polymer;
wherein at least about 30% by weight of the silver-based flakes have a particle size greater than about 6.0 μm, and at least about 30% by weight of the silver-based flakes have a particle size less about 6.0 μm.

41. The glass laminate structure of claim 40 wherein the polymer comprises thermoplastic polyurethane.

42. An electrically conductive bus for delivering heat to a glass surface, wherein the conductive bus comprises:
a solidified polymer; and
conductive filler particles distributed within the solidified polymer;
wherein the conductive bus has a resistivity below about 9.0×10⁻⁵ Ω·cm.

43. The conductive bus of claim 42 wherein the conductive filler particles comprise silver-based flakes and wherein at least about 30% by weight of the silver-based flakes have a particle size greater than about 6.0 μm and at least about 30% by weight of the silver-based flakes have a particle size less than about 6.0 μm.

44. The conductive bus of claim 42 wherein the conductive filler particles comprise silver-based flakes and wherein at least about 30% by weight of the silver-based flakes were manufactured under a first set of parameters and at least about 30% by weight the silver-based flakes were manufactured under a second set of parameters distinct from the first set of parameters.

45. A method of manufacturing a glass laminate structure for a vehicle, the method comprising:
depositing a bus bar composition comprising a polymer and conductive filler particles onto a surface of a first glass component;
superposing a second glass component over said surface of the first component on which the bus bar composition is deposited; and
compressing the first and second glass components together with the bus bar composition therebetween.

46. The method of claim 45 wherein the bus bar composition compressed between the first and second glass components forms a bus bar having a resistivity of less than about 9.0×10⁻⁵ Ω·cm.

47. The method of claim 45 wherein the polymer comprises thermoplastic polyurethane.

48. The method of claim 45 wherein the conductive filler particles comprise silver-based flakes.

49. The method of claim 45 wherein the polymer comprises thermoplastic polyurethane and the conductive filler particles comprise silver-based flakes.

50. A method of manufacturing a glass laminate structure for a vehicle, the method comprising:
depositing a bus bar composition comprising a polymer and conductive filler particles onto a surface of a first glass component, wherein the conductive filler particles comprise silver-based flakes and wherein at least about 30% by weight of the silver-based flakes have a particle size greater than about 6.0 μm, and at least about 30% by weight of the silver-based particles have a particle size less about 6.0 μm;
superposing a second glass component over said surface of the first component on which the bus bar composition is deposited; and
compressing the first and second glass components together with the bus bar composition therebetween.

51. A method of manufacturing a glass laminate structure for a vehicle, the method comprising:
depositing a bus bar composition comprising a polymer and conductive filler particles onto a surface of a first glass component which has been pre-shaped into a curved vehicle window configuration to form a bus bar structure on said surface;
superposing a second glass component pre-shaped into the curved vehicle window configuration over the surface of the first glass component with the bus bar structure thereon; and
compressing the first and second glass components together with the bus bar structure therebetween to form the glass laminate structure.

52. The method of claim 51 wherein the polymer comprises thermoplastic polyurethane and the conductive filler particles comprises silver-based flakes.

53. The method of claim 51 wherein the conductive filler particles comprise silver-based flakes and wherein at least about 30% by weight of the silver-based flakes have a particle size greater than about 6.0 μm, and at least about 30% by weight of the silver-based particles have a particle size less about 6.0 μm.

54. The method of claim 51 wherein the bus bar structure has a resistivity below about 9.0×10⁻⁵ Ω·cm.

55. The method of claim 51 comprising avoiding exposing the first glass component, during manufacturing the glass laminate structure, to any temperature above about 175° C. after the deposition of the bus bar composition onto the first glass component.

56. The method of claim 54 wherein the polymer is thermoplastic polyurethane and the conductive filler material is silver-based flakes.

57. The method of claim 54 wherein the conductive filler particles comprise silver-based flakes and wherein at least about 30% by weight of the silver-based flakes have a particle size greater than about 6.0 μm, and at least about 30% by weight of the silver-based particles have a particle size less about 6.0 μm.

58. The method of claim 51 comprising avoiding exposing the first glass component, during manufacturing the glass laminate structure, to any temperature above about 150° C. after the deposition of the bus bar composition onto the first glass component.

59. The method of claim 58 wherein the polymer comprises thermoplastic polyurethane and the conductive filler particles comprise silver-based flakes.
